(19) United States
(12) Patent Application Publication
(10) Pub. No.: US 2005/0125455 A1
(43) Pub. Date: Jun. 9, 2005

(54) Interactive television system

(75) Inventors: Jean-Marc Auger, Brunoy (FR); Jose Mendes Calvalho, Vincennes (FR); Patrice Mireux, Suresnes (FR)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/506,832

(22) PCT Filed: Feb. 13, 2003
(86) PCT No.: PCT/IB03/00530

(30) Foreign Application Priority Data
Mar. 12, 2002 (FR) 0203077

(51) Int. Cl. G06F 12/00; G06F 17/30

(52) U.S. Cl. 707/200

(57) ABSTRACT

The invention proposes an interactive a system comprising user units (1a, 1b, 1c) intended to display a content broadcast by a content supply unit (3). According to the invention, the user units are designed to transmit user data (Da, Db, Dc) to an application control unit (2). The application control unit determines pieces of content to be overlaid from user data received. It transmits overlay data to the user units and/or to the content supply unit. These overlay data are used by the user units and/or by the content supply unit for overlaying the pieces of content determined by the application control unit in the content to be displayed and/or in the content to be broadcast. Application: interactive television.

The invention relates to an interactive system comprising a content supply unit, an application control unit and at least one user unit, said user unit being provided with content reception and display means, user data production means and means of transmitting at least one user data item to said application control unit.

The invention also relates to a user unit comprising content reception and display means, user data production means and means of transmitting one or more user data items to an application control unit.

The invention also relates to an application control unit comprising means for receiving user data transmitted by at least one user unit intended to display a content supplied by a content supply unit.

The invention also relates to a content supply unit intended to supply a content.

The invention applies in particular to the broadcasting of televised programs.

The article “Interactive TV” by B. C. Fenton, published in the journal Radio Electronics, Vol. 59, No 12, pp. 45-47, describes an interactive television system which for example enables the users to participate in a televised game. This system comprises a content supply unit which supplies contents in a conventional manner, an application control unit and one or more user units. The application control unit transmits play instructions to the user units via an FM radio link. The user units return responses or scores to the application control unit via a telephone link. At the end of the game, the winner or winners are advised by the application control unit via the FM radio link.

The purpose of the invention is in particular to propose a system which allows a more concrete interaction by the user.

A system according to the invention and as described in the introductory paragraph is characterized in that:
said application control unit comprises means for determining one or more pieces of content from one or more user data items received, and transmission means for transmitting overlay data relating to said pieces of content, to said user unit and/or to said content supply unit,
said user unit and/or said content supply unit comprise overlay means for overlaying said piece or pieces of content in the content to be displayed and/or in the content to be supplied, using said overlay data.

The invention therefore makes it possible to overlay in a content pieces of content supplied directly or indirectly by the users who are displaying said content. The overlay can take place, in a centralized fashion, at the content supplier, and/or locally at the users. The user data which serves as a basis for the overlaying comprises for example an image, sound, video, responses to questions etc.

The invention makes it possible in particular to overlay locally, at each user, a piece of content which is peculiar to each user, for example targeted advertising, or, in the case of a televised game, an image or video of the user accompanied by the score of the user.

It also makes it possible to insert, at the content supply, a piece of content which concerns all the users, for example, in the case of a televised debate, the responses of the users to an opinion poll.

Advantageously said application control unit comprises selection means for selecting one or more user units and for transmitting to said content supply unit overlay data relating to one or more pieces of content determined from user data transmitted by the user unit or units selected, to the exclusion of the user data transmitted by the other user units.

This embodiment makes it possible for example to make one or more users participate in a concrete fashion in a debate or televised game, creating a sensation of participation close to that created by a physical presence on the television set. The selection made by the application controller can be modified over time so as to make a larger number of users participate.

A possibility of real interaction is thus offered to each user of the system. Such a system therefore makes it possible to increase the interest and motivation of the users for the content being broadcast.

The invention will be further described with reference to examples of embodiments shown in the drawings to which, however, the invention is not restricted.

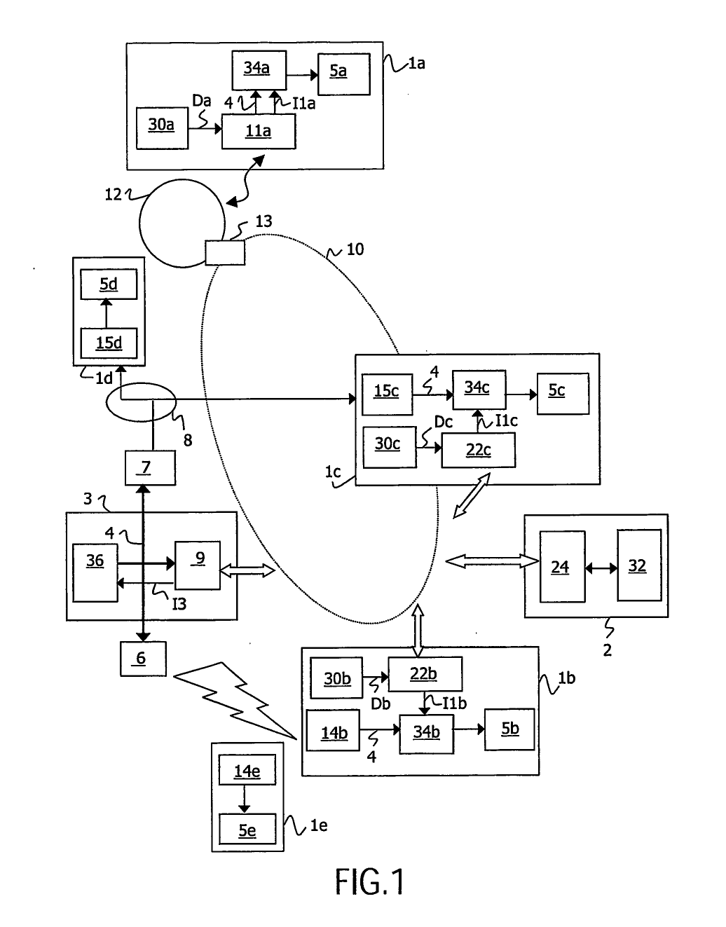

FIG. 1 is a diagram of an example of a system according to the invention,

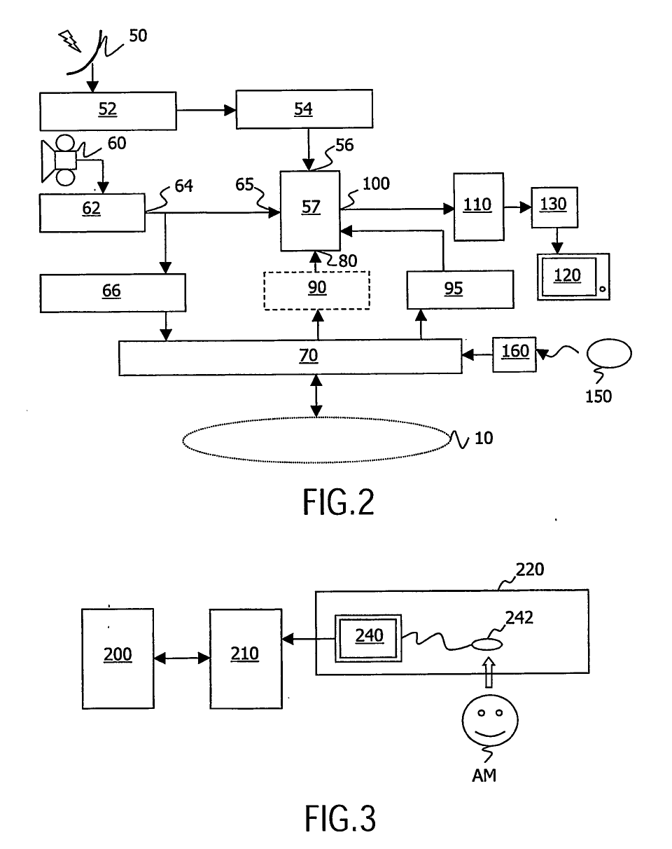

FIG. 2 is a functional diagram of an example of a user unit according to the invention,

FIG. 3 is a functional diagram of an example of an application control unit according to the invention,

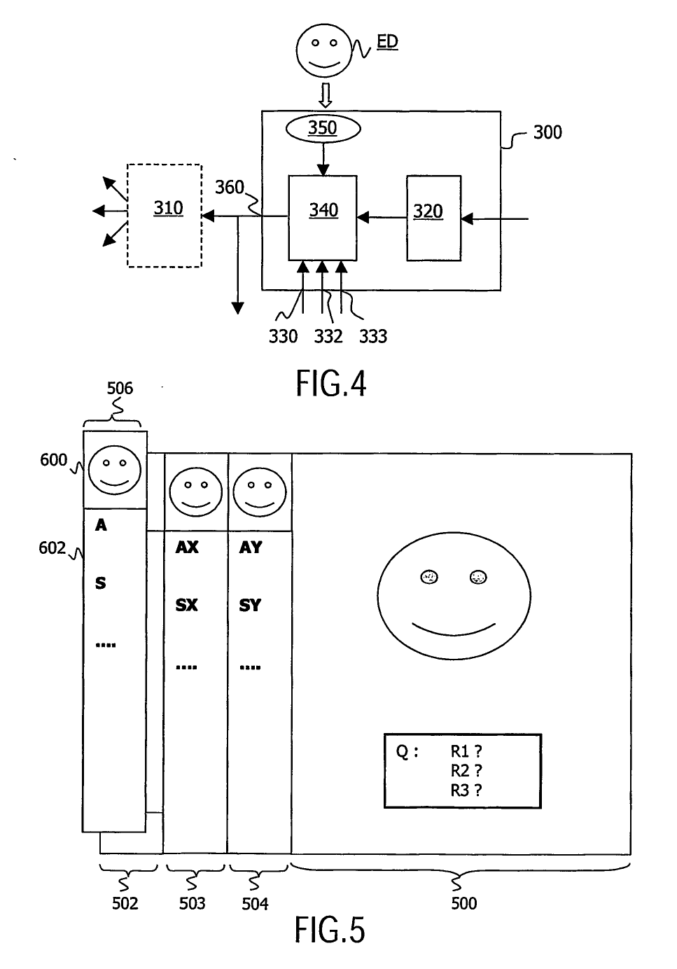

FIG. 4 is a functional diagram of an example of a content supply unit according to the invention,

FIG. 5 is a diagram of an example of content displayed on a display screen of a user unit according to the invention.

FIG. 1 depicts a diagram of an example of an interactive system according to the invention. The interactive system depicted in FIG. 1 comprises three user units according to the invention, 1a, 1b and 1c, two conventional user units 1d and 1e, one application control unit 2 and one content supply unit 3.

The content supply unit 3 is intended to supply a content 4. The content 4 is then broadcast to the user units 1a to 1e, which are provided with content display means, referenced 5a to 5e respectively. Various broadcast modes can be used. FIG. 1 depicts means 6 of broadcasting by radio and means 7 of broadcasting via a cabled network 8. In addition, the content supply unit 3 is provided with means 9 of access to the Internet 10 so that it can transmit and receive data via the Internet 10.

The user unit 1a is a mobile unit. It comprises radio transmission/reception means 11a for transmitting and receiving data via a mobile radio network 12. The mobile radio network 12 is provided with a point 13 of access to the Internet 10.

The other user units 1b, 1c, 1d and 1e are fixed units. The user units 1b and 1e comprise means of receiving radio signals, referenced 14b and 14e respectively. The user units 1c and 1d comprise means of receiving signals transmitted via the cabled network 8, referenced 15c and 15d respectively.

The user units 1b and 1c and the application control unit 2 also comprise means of access to the Internet 10, referenced 22b, 22c and 24 respectively.

Advantageously the connections to the Internet 10 are made using ADSL modems or cable modems connected to the switched telephone network and, for providing transportation in real time, the RTP (Real time Transfer Protocol) on UDP (User Datagram Protocol) on IP (Internet Protocol) protocols are used as transportation protocols.

The user units 1a, 1b, and 1c comprise user data production means, referenced 30a, 30b and 30c respectively. The user data produced are transmitted, at least partly, to the application control unit via the Internet 10. Advantageously, in order to eliminate any risk of fraud, the user data which are transmitted to the application control unit 2 are not stored locally by the user unit. In FIG. 1 the user data which are transmitted to the application control unit 2 are referenced Da, Db and Dc respectively. The user data production means 30a, 30b and 30c comprise for example a remote control making it possible to point to and select a screen area, and video capture means. The user data Da, Db and Dc contain for example a video or a photograph of the user, responses made by the user to questions posed in the broadcast content, and/or a definition of the profile of the user (for example his age, tastes etc).

For certain applications at least, for example for an interactive televised game, the screen area selected is associated with a selection time. Thus a response by the user to a question posed during the game consists of a triplet (x, y, t) where x and y are an abscissa and an ordinate identifying a selected screen area, and t is the time at which the selection was made. This embodiment avoids the user having to enter responses by means of a keyboard: this simplifies the user interface, and this reinforces the interactive character of the application.

The application control unit 2 comprises means 32 for determining one or more pieces of content from one or more user data received. Overlay data relating to said pieces of content are then transmitted by the application control unit 2 via the Internet 10 to one or more of the user entities 1a, 1b and 1c and/or to the content supply entity 3. In FIG. 1, the overlay data transmitted to the user units 1a, 1b and 1c are referenced I1a, I1b and I1c respectively. The overlay data transmitted to the content supply unit 3 are referenced I3. The overlay data I1a, I1b and I1c relate for example to personalized pieces of content, such as for example pieces of content indicating the scores of a user, and/or pieces of content containing targeted advertising according to the profile of a user etc. The overlay data I3 relate for example to pieces of content which concern a user selected by the application control unit 2, such as for example pieces of content containing a video of a selected user, and/or pieces of content indicating the score or response of a selected user.

In a first embodiment, the overlay data comprise the piece of content to be overlaid. In a second embodiment, a certain number of pieces of content are prerecorded, and the overlay data comprise an identifier for identifying one of the prerecorded pieces of content. This second embodiment makes it possible to limit the quantity of data to be transmitted.

The user units according to the invention 1a, 1b and 1c and the content supply unit 3 comprise overlay means 34a, 34b, 34c and 36 respectively for overlaying a piece of content in the content to be displayed, or respectively in the content to be supplied, using said overlay data.

The overlay means 34a, 34b, 34c and 36 consist for example of means of writing the piece of content to be overlaid, in an image memory which contains the content to be displayed or to be supplied, at a given location, and for a given length of time. The image memory is for example a YUV memory. The location and duration of the writing of the piece of content in the image memory constitute overlay characteristics. The overlay characteristics are supplied either once and for all during an initialization phase or bit by bit in the overlay data.

It should be noted that the overlay means can also use techniques of the “Chroma Key” type.

FIG. 2 shows a detailed functional diagram of an example of a user unit according to the invention. The user unit shown in FIG. 2 comprises an analog signal reception antenna 50 and a demodulator 52 for demodulating the analog signals received and supplying digital data. In the example described here, the digital data delivered by the demodulator 52 are coded to the MPEG-2 format. They are supplied to an MPEG-2 decoder referenced 54 for decoding. The decoded video data obtained at the output from the decoder 54 are carried to a first input 56 of a video multiplexing module 57.

The user unit shown in FIG. 2 also comprises a camera 60 intended to generate a video signal which is transmitted to a video acquisition system 62 (a “grabber”). An output 64 of the video acquisition system 62 is connected firstly to a second input 65 of the video multiplexing module 57 and secondly to an MPEG-2 encoder referenced 66. The coded video data obtained at the output from the coder 66 constitute first user data. They are supplied to a network interface 70 in order to be transmitted to the application control unit 2.

The network interface 70 also serves to receive the overlay data which are transmitted by the application control unit 2. According to the embodiment in question, said overlay data comprise pieces of content or identifiers for pieces of content, and possibly overlay characteristics:
the pieces of content are transmitted directly to a third input 80 of the video multiplexing module 57;
on the other hand, the identifiers for pieces of content must be decoded by a decoder 90 in order to recover the pieces of content which are associated with them; the pieces of content recovered are then delivered by the decoder 90 to the third input 80 of the video multiplexing module 57;
the overlay characteristics which are contained in the overlay data, or which are received during the initialization phase, are transmitted to a module 95 for controlling the video multiplexing module 57.

The existence of the decoder 90 depends on the embodiment in question. This is why it has been shown in dotted lines in FIG. 2.

The video multiplexing module 57 is provided with an output 100 connected to a YUV image memory referenced 110. The content of the image memory 110 is displayed on a screen 120 after passing through an analog to digital conversion module 130 (for example of the RAMDAC type).

Thus the user unit can overlay in a content received via the reception antenna 50 a piece of content generated locally by the camera 60 (for example a video of the user), and/or a piece of content determined by the application control unit 2 and for which it receives overlay data via the Internet 10.

The user unit depicted in FIG. 2 also comprises a remote control 150 for pointing to and selecting a screen area. The remote control 150 is intended to generate one or more signals representing a selection made on the screen and to transmit said signals to a data acquisition system 160. The data acquired by the data acquisition system 160 constitute second user data. They are supplied to the network interface 70 in order to be transmitted to the application control unit 2.

FIG. 3 depicts a functional diagram of an example of an application control unit according to the invention. According to FIG. 3, an application control unit according to the invention comprises a network interface 200, a microprocessor-based processing module 210 and a man-machine interface 220. The processing module 210 is intended to:
determine one or more pieces of content from one or more user data received,
transmit, to one or more user units, overlay data relating to one or more pieces of content,
select one or more users,
transmit, to said content supply unit, overlay data relating to one or more pieces of content which relate to the user or users selected.

The man-machine interface 220 consists for example of a display screen 240 and a mouse 242. It enables an application controller AM (“application manager”) to intervene in the aforementioned operations of determining pieces of content, selection and transmission of overlay data.

FIG. 4 depicts a functional diagram of an example of a content supply unit according to the invention. According to FIG. 4, a content supply unit according to the invention comprises a conventional video editing module 300. Optionally it also comprises a conventional content broadcasting module 310. The video editing module 300 comprises:
a network interface 320 for receiving overlay data,
several video inputs 330, 332 and 333 for receiving video flows produced by various sources, for example video flows generated by various cameras,
a microprocessor-based processing module 340 intended to perform conventional video editing operations, including overlaying operations,
a man-machine interface 350 enabling an editor ED to control the video editing operations, and
an output 360 for supplying a video content to be broadcast to the broadcast module 310 if it exists, and/or to an external broadcaster.

FIG. 5 gives an example of content displayed by a user unit according to the invention for an interactive televised game application. The content depicted in FIG. 5 comprises several parts:
parts 500, 502, 503 and 504 which belong to the broadcast content received by the user unit,
a part 506 which contains pieces of content 600 and 602 overlaid by the user unit.

The part 506 is overlaid at the location of the part 502. The part 500 presents a video editing of what is filmed on the television set. The parts 502, 503 and 504 are pieces of content overlaid by the content supplier in the content to be broadcast. The part 503 contains pieces of content relating to a selected user X. The part 504 contains pieces of content relating to a selected user Y. The piece of content 600 consists of a video of the user. The piece of content 602 is determined by the application control unit 2. It indicates the response A of the user to the question posed Q and the score S of the user.

The invention is not limited to the embodiments which have just been described by way of example. In particular, other interconnection solutions and other overlay methods can be used.

1. An interactive system comprising a content supply unit (3), an application control unit (2) and at least one user unit (1a, 1b, 1c), said user unit being provided with content reception (11a, 14b, 15c) and display (5a, 5b, 5c) means, user data production means (30a, 30b, 30c) and means (11a, 22b, 22c) of transmitting at least one user data item (Da, Db, Dc) to said application control unit (2), characterized in that:
said application control unit (2) comprises means (32) for determining one or more pieces of content from one or more user data items received, and transmission means (24) for transmitting overlay data (I1a, I1b, I1c and/or I3) relating to said pieces of content, to said user unit (1a, 1b, 1c) and/or to said content supply unit (3),
said user unit (1a, 1b, 1c) and/or said content supply unit (3) comprise overlay means (34a, 34b, 34c and/or 36) for overlaying said piece or pieces of content in the content to be displayed and/or in the content to be supplied, using said overlay data.

2. An interactive system as claimed in claim 1, characterized in that a plurality of predefined pieces of content are stored in said user unit and/or in said content supply unit, said predefined pieces of content being identified by a content piece identifier, and in that the overlay data transmitted by said application control unit comprise a content piece identifier.

3. An interactive system as claimed in claim 1, characterized in that the overlay data transmitted by said application control unit comprise the piece of content to be overlaid.

4. An interactive system as claimed in claim 1, characterized in that said application control unit comprises selection means for selecting one or more user units and for transmitting to said content supply unit overlay data relating to one or more pieces of content determined from user data transmitted by the user unit or units selected, to the exclusion of the user data transmitted by the other user units.

5. An interactive system as claimed in claim 1, characterized in that said user data comprise an image and/or sound and/or video.

6. An interactive system as claimed in claim 1, characterized in that said user unit comprises means for producing a piece of content to be overlaid from user data which it has produced.

7. A user unit (1a, 1b, 1c) comprising content reception means (11a, 14b, 15c) and content display means (5a, 5b, 5c), user data production means (30a, 30b, 30c) and means (11a, 22b, 22c) of transmitting one or more user data (Da, Db, Dc) to an application control unit (2), characterized in that it comprises:
means (11a, 22b, 22c) of receiving overlay data (I1a, I1b, I1c) transmitted by said application control unit (2), said overlay data relating to at least one piece of content determined by said application control unit from at least one of said transmitted user data,
overlay means (34a, 34b, 34c) for overlaying said piece of content in the content to be displayed, using said overlay data.

8. An application control unit (2) comprising means (24) for receiving user data (Da, Db, Dc) transmitted by at least one user unit (1a, 1b, 1c) intended to display a content supplied by a content supply unit (3), characterized in that it comprises means (32) for determining one or more pieces of content from one or more user data received, and means (24) of transmitting overlay data (I1a, I1b, I1c and/or I3) relating to said pieces of content, to said user unit (1a, 1b, 1c) and/or to said content supply unit (3), with a view to the overlaying of said pieces of content in the content to be displayed and/or in the content to be supplied.

9. A content supply unit (3) intended to supply a content, characterized in that it comprises:
means (9) of receiving overlay data (13) transmitted by an application control unit (2), said overlay data relating to at least one piece of content determined by said application control unit from at least one user data item (Da, Db, Dc) transmitted by at least one user unit (1a, 1b, 1c) provided with means (5a, 5b, 5c) of displaying the content supplied,
overlay means (36) for overlaying said piece of content in the content to be supplied, using said overlay data.
